(19) United States
(12) Patent Application Publication
(10) Pub. No.: US 2012/0102136 A1
(43) Pub. Date: Apr. 26, 2012

(54) DATA CACHING SYSTEM

(75) Inventors: Piotr Srebrny, Andrychow (PL); Thomas Plagemann, Skjetten (NO); Vera Goebel, Skjetten (NO); Andreas Mauthe, Lancaster (GB)

(73) Assignees: LANCASTER UNIVERSITY, Lancaster (GB); UNIVERSITY OF OSLO, Oslo (NO)

(21) Appl. No.: 13/277,733

(22) Filed: Oct. 20, 2011

Related U.S. Application Data
(60) Provisional application No. 61/405,461, filed on Oct. 21, 2010.

(51) Int. Cl. G06F 15/167

(52) U.S. Cl. 709/213

(57) ABSTRACT

Provided herein are systems, uses, and processes relating to network communications. For example, provided herein are systems, uses, and processes for increasing transmission efficiency by removing redundancy from single source multiple destination transfers.

### CROSS-REFERENCE TO RELATED APPLICATIONS

This application claims the benefit of U.S. Provisional Application 61/405,461, filed Oct. 21, 2010, the entire contents of which are incorporated herein by reference.

### FIELD OF INVENTION

Provided herein are systems, uses, and processes relating to network communications. For example, provided herein are systems, uses, and processes for increasing transmission efficiency by removing redundancy from single source multiple destination transfers.

### BACKGROUND OF THE INVENTION

The original design of the Internet architecture did not take the single source multiple destination data transfers, namely multicast into account. However, it was quickly recognized that this functionality is necessary for applications like distributed databases, distributed computation, or teleconferencing, which require efficient multiple destination data delivery. With content delivery over the Internet being more prominent, multicast is increasingly becoming an important feature. Unfortunately, the Internet still lacks widely deployed multicast services. In fact, it has been reported that only slightly more than 2% of autonomous systems were multicast enabled.

The lack of multicast services on the Internet accounts for increasingly more redundancy in the network traffic. This increase has gained momentum with the advent of multimedia services on the Internet such as IPTV. At present, content providers often use unicast connections to reach their receivers scattered across many autonomous systems. This results in numerous packets carrying the same payload crossing the same path for many hops before they reach their final destinations.

What is needed in the art are systems and processes for increasing transmission efficiency by removing redundancy from single source multiple destination transfers.

### SUMMARY OF THE INVENTION

Provided herein are systems, uses, and processes relating to network communications. For example, provided herein are systems, uses, and processes for increasing transmission efficiency by removing redundancy from single source multiple destination transfers.

The technology finds use as a link layer caching mechanism that operates on point-to-point links for single source multiple destination data transfers. This specific type of traffic exhibits properties such as high redundancy with temporal clustering that can be exploited to make the transmission more efficient by caching. The technology thus enables one-to-many data transfer in the Internet with multicast performance. From the receivers' point of view a unicast connection is established to the server. In some embodiments, a small amount of extra effort is important for the server implementation to support the technology in that it needs to mark packets that are part of single source multiple destination transfer as cacheable, add some header information, and send packets with the same payloads within a short time interval. These tasks can be achieved with a negligible overhead using a simple and flexible API.

Besides the simple programming abstraction of unicast connections, the technology saves bandwidth in the network, which is especially important in future applications that rely on single source multiple destination transfers. Furthermore, the technology maintains fairness with respect to bandwidth sharing in the Internet. This technology can be incrementally deployed. ISPs that would place just very few routers enabled with the technology after a popular server will gain substantially through bandwidth sharing.

Provided herein is a system for managing delivery of a data packet over a network, the system comprising: a cache management unit operably linked to the network, said cache management unit configured to examine a content header associated with the data packet and determine if a cache hit or a cache miss has occurred; a cache store configured to construct a new data packet by associating the content header with a previously stored payload that is the same as the payload if a cache hit has occurred or to store a copy of the payload if a cache miss has occurred, and to prepare the data packet or the new data packet for delivery to an output interface.

In some embodiments, the cache management unit and said cache store reside on one or more routers. In some embodiments, the system further comprises a server support configured to associate said content header with said data packet and transmit the data packet via the network. While not limited in the relative locations of the server support ant the router on the network, in some embodiments the server support and said router are remote from one another on the network.

In some embodiments of the systems provided, a content header is used to mark cacheable packets. While not limited in the content of the content header, in some embodiments the content header comprises a cache index field, a payload identifier, and a payload size. Accordingly, in some embodiments, the data packet is a cacheable data packet. While not limited to the types and placements of the content header, some embodiments provide that the content header is placed in the IPv6 extension header and some embodiments provide that the content header is placed between a link layer header and an IP header.

In some embodiments, the cache management unit receives the data packet from an upstream node of the network, the cache store receives the data packet from the cache management unit, and a downstream node of the network receives the data packet from the cache store. In some embodiments, the server support marks a data packet that is part of a single source multiple destination transfer as cacheable, adds a content header to the data packet, and sends data packets with the same payloads within a time interval that allows caching. In some embodiments, the upstream node is a router or a server support. In some embodiments, the cache management unit is placed at a link entrance and the cache store is placed at a link exit. Some embodiments provide that the cache store further comprises a memory slot for storing the payload and the cache management unit further comprises a table for storing the payload identifier associated with the payload, wherein the memory slot is addressable by a payload index and the table is addressable by a payload identifier index, and wherein the payload index and the payload identifier index are the same for a stored payload and its corresponding stored payload identifier.

Provided herein are systems for managing data by caching. Accordingly, some embodiments provide that if a cache hit has occurred the cache management unit identifies a previously stored payload identifier in the table that caused the cache hit, determines a second payload identifier index of the previously stored payload identifier, writes the second payload identifier index into the cache index field of the content header, removes the payload from the data packet, and transmits the data packet to the link exit; and the cache store examines the data packet at the link exit, determines that the data packet consists of only the content header, reads the second payload identifier index from the cache index field of the content header, evaluates a second payload index that is the same as the second payload identifier index, selects a previously stored payload in the memory slot that is addressed by the second payload index, attaches the content header to a copy of the previously stored payload to construct a new data packet, and prepares the new data packet for delivery to an output interface; and if a cache miss has occurred: the cache management system replaces a previously stored payload identifier in the table with the payload identifier of the data packet that caused the cache miss, determines a second payload identifier index of the payload identifier that was inserted into the table, writes the second payload index into the cache index field of the content header, and transmits the data packet to the link exit; and the cache store examines the data packet at the link exit, determines that the data packet consists of a content header and a payload, reads the second payload identifier index from the cache index field of the content header, evaluates a second payload index that is the same as the second payload identifier index, replaces a previously stored payload in the memory slot with a copy of the payload such that the payload identifier in the table and the corresponding copy of the payload in the memory slot have a payload identifier index and a payload index that are the same, and prepares the data packet for delivery to an output interface.

In some embodiments, a replacement policy governs replacing a previously stored payload identifier in the table. In more specific embodiments, the replacement policy is a FIFO replacement policy. While the technology is not limited in the data structures that can be used for storage, some embodiments provide that the table is built using a hash table.

In some embodiments, the cache management unit is configured manually based on a size of the cache store and in some embodiments the cache management unit and the cache store are configured automatically based on a capacity of a link that connects the cache management unit and the cache store. Some embodiments provide that the payload identifier is stored together with the payload in the memory slot. Additional embodiments provide that if a cache hit has occurred the cache store reads the payload identifier of the content header, compares the payload identifier of the content header to the stored payload identifier, and drops the payload if the payload identifier of the content header does not match the stored payload identifier.

In some embodiments provided, preparing the data packet or the new data packet for delivery to an output interface comprises removing the content header. In some embodiments, a size of the cache store is based on a cache hold time. In some embodiments, the cache hold time is in the range of 1 ms-500 ms, preferably 5 ms-50 ms. In a particular embodiment, the cache hold time is 10 ms.

Also provide herein are uses providing for a single source multiple destination transfer of data. While not limited in the types of data that can be transmitted or the types of applications in which the technology might find use, in some embodiments the data comprises live streaming media or a bulk data transfer and in some embodiments the data comprises video conferencing, IP radio, IPTV, or a software update.

Provided herein are computer implemented processes for nonredundant data transfer over a network comprising the steps of associating a content header with a data packet, the data packet comprising a payload; at a node on said network, determining if a cache hit or a cache miss has occurred; if a cache hit has occurred, constructing a new data packet by associating the content header with a previously stored payload that is the same as the payload; if a cache miss has occurred, storing a copy of the payload; and preparing the new data packet or the data packet for delivery to an output interface. In some embodiments, said node is a router. In some embodiments, said router is located at a remote location on the network.

In some embodiments of the technology, associating a content header with a data packet is performed by a server support, determining if a cache hit or a cache miss has occurred is performed by a cache management unit, and constructing a new data packet, storing a copy of the payload, and preparing the new data packet or the data packet for delivery to an output interface are performed by a cache store. While not limited in the structure or topology of the network, provided herein are embodiments wherein the cache management unit and the cache store are on one or more routers.

In some embodiments of the processes provided, a content header is used to mark cacheable packets. While not limited in the content of the content header, in some embodiments the content header comprises a cache index field, a payload identifier, and a payload size. In some embodiments the data packet is a cacheable data packet. The processes provided herein contemplate that new technologies may come about for providing internet addresses. Thus, while not limited in the address protocol, some embodiments provide herein that the content header is an IPv6 extension header and some embodiments provide herein that the content header is placed between a link layer header and an IP header.

In some embodiments, the cache management unit receives the data packet from an upstream node of the network, the cache store receives the data packet from the cache management unit, and a downstream node of the network receives the data packet from the cache store.

Some embodiments provide for marking a data packet that is part of a single source multiple destination transfer as cacheable; adding a content header to the data packet; and sending data packets with the same payloads within a time interval that allows caching. In some embodiments, marking, adding, and sending are performed by the server support.

Some embodiments place the cache management unit at a link entrance and placing the cache store at a link exit. In some embodiments, the cache store further comprises a memory slot for storing the payload and the cache management unit further comprises a table for storing the payload identifier associated with the payload, wherein the memory slot is addressable by a payload index and the table is addressable by a payload identifier index, and wherein the payload index and the payload identifier index are the same for a stored payload and its corresponding stored payload identifier.

Some embodiments provide processes that, if a cache hit has occurred, are drawn to identifying a previously stored payload identifier in the table that caused the cache hit; determining a second payload identifier index of the previously stored payload identifier; writing the second payload identifier index into the cache index field of the content header; removing the payload from the data packet; transmitting the data packet to the link exit; determining that the data packet consists of only the content header; reading the second payload identifier index from the cache index field of the content header; evaluating a second payload index that is the same, as the second payload identifier index; selecting a previously stored payload in the memory slot that is addressed by the second payload index; attaching the content header to a copy of the previously stored payload to construct a new data packet; and preparing the new data packet for delivery to an output interface; and if a cache miss has occurred: replacing a previously stored payload identifier in the table with the payload identifier of the data packet that caused the cache miss; determining a second payload identifier index of the payload identifier that was inserted into the table; writing the second payload index into the cache index field of the content header; transmitting the data packet to the link exit; examining the data packet at the link exit; determining that the data packet consists of a content header and a payload; reading the second payload identifier index from the cache index field of the content header; evaluating a second payload index that is the same as the second payload identifier index replacing a previously stored payload in the memory slot with a copy of the payload such that the payload identifier in the table and the corresponding copy of the payload in the memory slot have a payload identifier index and a payload index that are the same; and preparing the data packet for delivery to an output interface.

In some embodiments, some steps are performed by the cache management unit and some steps are performed by the cache store at the link exit. In some embodiments, replacing a previously stored payload identifier in the table is governed by a replacement policy. In a specific embodiment, the replacement policy is a FIFO replacement policy.

While not limited in the types of data structures that can be employed, some embodiments contemplate building the table using a hash table. Some embodiments provide for configuring the cache management unit manually based on a size of the cache store and some embodiments provide for configuring the cache management unit and the cache store automatically based on a capacity of a link that connects the cache management unit and the cache store.

Contemplated herein are methods for handling errors in data transmission Accordingly, some embodiments provide for storing the payload identifier together with the payload in the memory slot. In addition, some embodiments provide processes that, if a cache hit has occurred, are drawn to reading the payload identifier of the content header; comparing the payload identifier of the content header to the stored payload identifier; and dropping the payload if the payload identifier of the content header does not match the stored payload identifier.

In some embodiments, preparing the data packet or the new data packet for delivery to an output interface comprises the additional step of removing the content header. In some embodiments, a size of the cache store is determined based on a cache hold time. In some embodiments, the cache hold time is in the range of 1 ms-500 ms and in some preferred embodiments the cache hold time is 5 ms-50 ms. In some even more preferred embodiments, the cache hold time is 10 ms.

Additional embodiments will be apparent to persons skilled in the relevant art based on the teachings contained herein.

### DETAILED DESCRIPTION OF THE INVENTION

Provided herein are systems, uses, and processes relating to network communications. For example, provided herein are systems, uses, and processes for increasing transmission efficiency by removing redundancy from single source multiple destination transfers.

### DEFINITIONS

To facilitate an understanding of the present technology, a number of terms and phrases are defined below. Additional definitions are set forth throughout the detailed description.

As used herein, “a” or “an” or “the” can mean one or more than one. For example, “a” packet can mean one packet or a plurality of packets.

As used herein, a “cache hit” means that the payload of the data packet has already passed through the link and has been stored in the cache. In particular, if a payload identifier of a packet entering a link is found in the CMU table, it is a cache hit. This means that the packet payload is in the cache store on the exit side of the link and there is no need to transmit it again.

As used herein, a “cache miss” means that the payload of the data packet is not currently stored in the cache. In particular, if a payload identifier of a packet entering a link is not found in the CMU table, it is a cache miss. This means that the packet payload is not present in the cache store on the exit side of the link.

As used herein, a “payload identifier” identifies a packet payload uniquely at the source and when it is combined with the source address it identifies a packet uniquely in the Internet. The terms “payload ID” and “ID” are also used and have the same meaning as “payload identifier”.

As used herein, the term “Internet” refers to any collection of networks using standard protocols. For example, the term refers to a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc.). The term is also intended to encompass non-public networks such as private (e.g., corporate) Intranets.

As used herein the term “transmitting” refers to the movement of information (e.g., data) from one location to another (e.g., from one device to another) using any suitable means.

As used herein, the term “table” refers to any data structure for storing data such as, but not limited to, a keyed relational database, a linked list, a flat-file record, etc. Individual data entries in a table can be associated with a value (e.g., an index or key, etc.). The data entries can be accessed through their association with the index or key, etc.

As used herein, a “cacheable data packet” is a data packet comprising a payload that is redundant because it is the same payload as that associated with another data packet.

### Embodiments of the Technology

Although the disclosure herein refers to certain illustrated embodiments, it is to be understood that these embodiments are presented by way of example and not by way of limitation.

1. Overview of the Technology

The technology provided herein relates to reducing redundancy in single source multiple destination datagram delivery in the Internet. In the absence of widely deployed multicast solutions, this type of transmission is solved by a superpositioning of unicast transmissions. Obviously, this leads to multiple transmissions of the same payload over the same link.

The overhead introduced by multiple transmissions of the same element over the same communication channel can be addressed by caching. The following sections present two fundamental design issues for caching. The first issue is where to place cache elements. The second issue is whether a source should be aware or unaware of caching.

Placement of Cache Elements

According to typical assumptions, a link capacity is limited by the bit transmission rate. Thus, the smaller packets are the more can be transmitted within a time unit. Placing caching mechanism on the edges of the link entity will reduce the size of a packet that carries redundant payload to the size of the packet header. This configuration is also in line with the fact that the link caches are very simple when they are installed on the link edges. This is due to the deterministic packet behaviour on a link.

A single link cache does not require any cooperation with other caches. It is a self-standing unit. The only information the cache requires is carried by a cacheable packet. Link caches are transparent to routers. All cacheable packets that were transmitted without payload over a link are reconstructed inside the shared memory and then they are processed by a router. Before a cacheable packet is moved to the output interface, it is again subjected to the caching mechanism and its size may be reduced. Since cached packets are moved between network interfaces and shared memory and the technology implements a very simple caching mechanism, the technology's impact on a router's switching capacity is negligible.

Caching-Aware Source

A second design decision is that a source should be aware of caching. A caching aware source cooperates with the network. It can ensure that the packets that carry the same payload are transmitted within the minimum interval time. Additionally, it can provide three key information elements to the network that simplifies caching. First, it marks packets that carry the same payload as cacheable packets. Packets that do not carry duplicate payloads are not marked and are not considered for caching in the network. This in turn increases cache efficiency because it does not waste storage space for unique payloads. Second, the payload part of a packet is of variable size. The source can easily provide the information about the payload size. Thus, network caches know immediately which part of a packet to cache. Third, a source can create an identifier for each payload that, when combined with the source address, is unique to the Internet. Thus, caches perform matching based on payload IDs instead of a whole payload match. This greatly relieves network caches both in terms of processing and memory requirements.

A source unaware of caching does not support the network. Caching is done transparently to the source and the network caches do not have the aforementioned advantages. These caches would require larger storage space to achieve a comparable efficiency (due to the wasted storage room for non-redundant payloads). They need to determine the payload part and need to compare the whole payload when a cache hit occurs. However, the main advantage of transparent caching is that it does not require any change at the source. Moreover, the transparent caching does not match payloads according to the IDs created at the source, rather it compares whole payloads. Thus, the same payloads that originate from different sources can be matched, which might enable to cache content from unrelated sources. Nevertheless, the present technology relates to single source multiple destination datagram delivery and inter source matches are out of the scope of this work. Furthermore, the aim is to minimize the cache's size, which in turn minimizes the probability for inter-source matches. The advantages of transparency are achieved by employing large caches and complex cache matching algorithms which may be too expensive for the Internet in the near future.

2. Design Details of the Technology

Based on these fundamental design decisions, the present technology has been developed. Its detailed design is described in this section.

Content Header

The caching aware source marks packets as cacheable packets and provides information on payload ID and payload size of the packet. The information is placed in an extension header called the content header. Each packet that carries a content header is a cacheable packet. The technology works only on cacheable packets and non-cacheable packets pass it untouched. The header is created at the source and contains three fields: the cache index (INDEX), the payload ID (P ID), and the payload size (P SIZE). The cache index is an administrative field for the caching mechanism and it points to the location of the payload in the cache store. The two remaining fields are filled by the source before packet transmission. The payload size describes the packet tail size which is cacheable. In some embodiments, the payload is assumed to be at the tail of a packet. The payload ID identifies packet payload uniquely at the source and when it is combined with the source address it identifies a packet uniquely in the Internet.

Depending on the IP version available in a network, there are two possible locations for the content header. If the technology works in an IPv6 network, the IPv6 extension header is used to implement the content header. However, IPv6 is rarely deployed in the Internet at present and it is more likely that the caching mechanism is employed in IPv4-based networks. Since the IPv4 header does not provide any functionality to implement the content header, the approach of the MPLS protocol is used. That is, the content header is located between link layer header (L2) and IP header (L3). The CS unit is responsible for removing the content header when a cacheable packet enters a router and the CMU unit is responsible for inserting the content header before a packet enters again a caching link.

Caching Mechanism

Caching is done per link and is separated into a management unit and a cache store. The cache management unit (CMU) is placed on the link entry and the cache store (CS) is placed on the link exit. The CMU is in full control of the CS. It has a table where it keeps information on payloads stored in the CS. The number of the CMU table entries is the same as the number of the SC slots. Link cache behavior is defined for cache hit and cache miss events in the following way:
Cache hit: If a payload identifier of a packet entering a link is found in the CMU table, it is a cache hit. This means that the packet payload is in the cache store on the exit side of the link and there is no need to transmit it again. Thus, CMU first puts the index of this payload identifier into the INDEX field in the content header. Next, it removes the payload and transmits only the header part of the packet. When the header arrives on the link exit the payload with the INDEX in the cache store is attached to it. Then, the whole packet is moved for further processing to the router.
Cache miss: If a payload identifier of a packet entering a link is not found in the CMU table, it is a cache miss. This means that the packet payload is not present in the cache store on the exit side. The CMU handles the cache miss by removing one entry from the table according to the selected cache replacement policy and inserts instead the payload identifier of the packet that caused the cache miss. Next, it inserts the index where the payload identifier was inserted in the CMU table into the INDEX field of the packet content header. Finally, the packet is transmitted over the link. Upon arrival at the link exit the payload is stored at the location pointed to by the INDEX. The previously stored payload can be safely overwritten since it has been evicted from the cache by the CMU. The payload identifier in the table and the corresponding payload in the cache store have the same indexes.

CMU Design Issues

There are two technical issues related to the CMU design: First, the CMU controls the placement of payloads in the CS. Therefore, it is necessary for the CMU to know the CS size. This must be solved during the cache initialization. There are two alternatives: either the CMU is configured manually or automatically. While manual configuration is straightforward, automatic configuration may cause problems on a directed link where the CS cannot communicate with the CMU directly (e.g., satellite links). In some embodiments, the CMU is configured manually. Second, the CMU has the table containing identifiers of payloads located in the cache store. It performs payload identifier lookup for each cacheable packet. Thus, depending on the table size, the lookup operation may become the bottleneck of the caching mechanism. This issue is addressed by the principle to keep caches small. It is sufficient to keep cacheable packets for several milliseconds in a cache, which results in a small size of the CMU table. Consider a 1 Gbps link as an example. If it is assumed that the average payload size is 1 KB, and link traffic is cached for 10 ms, a total amount of 1310 CMU entries results. Additionally, if it is taken into account that only a part of the total link traffic is the cacheable traffic the number of entries can be further reduced. This size of a lookup table can be efficiently built based on table hashing techniques known to those of ordinary skill in the art.

It should be noted that a cache miss due to a false negative (i.e. a payload identifier is not found in the table) affects only the cache efficiency but does not cause errors in packet transmission (i.e. a whole packet is sent instead of a header part of a packet).

CS Design Issues

The CS performs two tasks. When the CS receives a packet with a payload it stores the payload into the memory slot pointed to by the INDEX from the packet content header. When the CS receives a packet without a payload it attaches the payload from the memory slot pointed to by the INDEX from the packet content header. Thus, two issues of the CS design are the sizes of the CS and the payload memory slots. Computational capabilities are not a limiting factor.

A link queue of a router is designed to accommodate approximately 250 ms of the total traffic flowing through an associated link. It is estimated that the cache should accommodate several milliseconds of cacheable traffic flowing through a link. Furthermore, cacheable traffic is only a fraction of the total traffic. Thus, the storage requirements are very modest when compared to a link queue storage.

One embodiment uses a fixed size memory slot for all payloads. The memory slot size is equal to the corresponding link MTU size. This could cause underutilization of the available memory when storing payloads of variable size.

Cache Size

It is very difficult to give a rough number of the cache sizes in the Internet. In general, larger caches are more efficient, but on the other hand they require more processing capacity and more storage space. In some embodiments, all caches are scaled according to the associated link capacity. Nevertheless, in some embodiments a more sophisticated schema could be more appropriate and efficient.

The following observation is used to estimate the order of magnitude of the desired cache size. Consider a source that sends the same data chunk to multiple destinations in a network enabled with the present technology. Before packets carrying the data chunk enter the first hop link they are subjected to the CMU. Thus, only the first packet carries payload over the link while the remaining packets are without payload. The resulting packet chain is alternatively called a “packet train”. Considering the packet train structure, it is sufficient to create caches that could hold a payload carried in the first packet until the last header of a packet train arrives. Therefore, the desired cache hold time depends on the packet train duration time. This in turn depends on the source uplink speed and the number of destinations.

Sizes of packet trains have been calculated that can be inserted into a network within a given time window. The results for different uplink speeds and for three different time windows have been compiled. The packet header size on link varies depending on the link technology. In the calculations it is assumed that the minimum Ethernet framing for a packet header is 84 bytes including inter-frame gap for all uplink speeds. In the calculations, the packet train duration time is measured as the difference between the time when the first packet and the last packet were transmitted by the source. Since only the head of a packet train carries the payload, the duration time of the packet train is equal to (N−1)*tₛ where N is the number of receivers and tₛ is the time to serialize one packet header.

Considering the number of packet headers that can be inserted into a network for the different uplink speeds, in some embodiments a cache hold time of 10 ms is used. This hold time is supported by the following observations:
1. The faster the uplink speed is the more packets a source can insert into a network within a given time. It is expected that sources with slow uplink speed send data to a few destinations while sources with fast uplink speed send data to many destinations.
2. Sources with a slow uplink speed often employ header compression techniques to shrink the header size to only a few bytes. Thus, slow sources may insert many more packet headers into a network within a given time.
3. The results do not determine the maximum number of receivers. For example, a source with 1 Mbps uplink speed can still send data to more than 16 receivers, but in such a case the packet train duration time is larger than 10 ms. Therefore, it may cause additional payload transmissions, thus decreasing the overall efficiency.
4. Sources with a fast uplink speed generate much more cacheable traffic in a network than sources with a slow uplink speed. Therefore, the major part of bandwidth savings is due to caching of traffic originating from the fast sources. The decrease of efficiency due to the slow sources that send to many destinations is low.

Handling Errors on a Link

So far it has been assumed that there is no packet loss and no packet reordering on a link. However, even though these events occur very rarely on current links it is important that the caching mechanism should provide additional protection against them.

It should be noted that the link cache is built at the edge of the link entity. Thus, packet loss or packet reordering in a router does not affect the link caching. The only packet loss and packet reordering that is of concern to us is packet loss and packet reordering on that particular single link.

Packet Loss

Packet loss on a link may affect the caching mechanism and cause cache inconsistencies, but only when the lost packet carried a payload. The following example illustrates this case. A cacheable packet with a new payload enters a link and is processed by the CMU. The packet causes a cache miss. The CMU inserts the packet payload ID into the table and puts the payload ID index into the packet header. Next, the packet is sent on the link but is lost. Thus, it does not reach the cache store and the payload is not stored on the link exit. Now, the payload ID in the CMU table does not reflect the correct payload in the cache store. Hence, the link cache is inconsistent. Each packet that enters the link and has the same payload ID as the lost packet causes a cache hit. Its payload is removed and only the header part is sent over the link. When the header arrives on the link exit a wrong payload is attached to it and the wrong payload is delivered to the packet destination.

To protect against errors caused by cache inconsistency the payload ID is stored together with the payload in the cache store on the exit side of the link. Since the packet header always carries its payload ID, it can be compared with the payload ID in the cache store before the payload is attached. If the payload ID carried by the header does not match the payload ID in the cache store, the packet can be dropped. The loss on a link of a cacheable packet with payload causes the dropping of the whole packet train. However, the loss of a packet without payload does not affect any subsequent packets.

Packet Reordering

Packets that exit a link out of order may cause a temporal cache inconsistency. A simple illustration of this problem is the following. Consider two packets. The first packet entering the link causes a cache hit. Thus, its payload is removed and the CMU puts the corresponding index value into the packet header. The second packet entering the link causes a cache miss and the CMU chooses an index according to a replacement policy, which appears to be the same as the index carried by the first packet. If the two packets are reordered on the link, the payload of the second packet will overwrite the payload being referred to by the first packet. Thus, the first packet receives a wrong payload, which is a severe error.

The solution that protects against errors due to packet loss does also protect against errors caused by packet reordering. Applying it to the above example would cause the drop of the first packet (which arrives second on the link exit). Depending on the probability of the packet reordering on a link, it is contemplated that more sophisticated solutions might be applied to that link. However, in embodiments provided herein the packet dropping policy is sufficient.

### EXAMPLE

1. Theoretical Evaluation of the Technology

To give an insight into the efficiency of the proposed link layer caching, it is compared with a “perfect” multicast scheme. The perfect multicast slightly differs from the IP Multicast. It does not require any additional signaling to establish a multicast tree and to deliver a datagram to receivers. Thus, it is strictly theoretical, but yet it provides a good reference point.

In order to compare the efficiencies, we use the following metric expressed as the ratio of the total number of multicast links over the total number of unicast links that are traversed by a datagram to reach all the receivers in a group.

$$δ = 1 - \frac{{L}_{m}}{{L}_{u}} \qquad ( 1 )$$

According to this metric, when the value equals zero, there is no difference in the number of hops. As the value approaches one, the benefit of using multicast increases. To give a simple example of the metric usage, consider a topology resembling the letter Y. Sending one packet from the bottom to both top tips requires traversing four links using unicast, while only three links are traversed using multicast. Thus, we have d=1−¾=¼.

Header Costs

The first reduction in the efficiency of the technology, when compared to the perfect multicast, lies in the fact that it does not have a common header for all destinations. The header part of a packet sₕ is unicast while the payload part sₚ is multicast. This is reflected in modified (1) for the technology efficiency:

$${δ}_{c} = 1 - \frac{{s}_{h} {L}_{u} + {s}_{p} {L}_{m}}{( {s}_{h} + {s}_{p} ) {L}_{u}} \qquad ( 2 )$$

If the ratio of the header size to the payload size is denoted by r (r=sₕ/sₚ), the reduced efficiency can be expressed using the perfect multicast efficiency δ (1) and the ratio r in the following way:

$${δ}_{c} = \frac{1}{1 + r} δ \qquad ( 3 )$$

When the ratio r decreases, the efficiency of the link layer caching approaches the perfect multicast efficiency. For example, using UDP packets of MTU size in the Ethernet networks, efficiency is reduced by 5%. (The header part is 84 bytes long which is the minimum sized packet in the Ethernet network while the payload part is 1416 bytes long).

Finite Cache Size

The second reduction of the efficiency is due to finite cache size resulting in additional transmissions of a payload over the same link. To illustrate this, consider a packet train traversing a link. In the perfect case, only the first packet from the packet train carries the payload over the link and the trailing packets consist only of the header part. However, due to other cacheable packets traversing this link, the payload might be evicted from the cache store before the whole packet train has passed the link. This will cause additional transmission of the payload reducing the total efficiency.

2. Simulation of the Technology

Simulation Setup

The efficiency of multicast mainly depends on the number of receivers. However, the more receivers, the longer the packet train is and longer packet trains require larger caches, which contradicts the principle to keep caches small. Simulations can provide insight into the relationship between the caching efficiency and the number of receivers.

The multicast tree topology collected in the mwalk project was used. It was created using the mwalk tool by traversing paths from a source to a randomly chosen set of receivers. The tree topology has 1950 leaves and is claimed to retain the general characteristics of interdomain multicast trees. It is assumed that the multicast spanning tree is to a great extent similar to the tree created by a superposition of unicast routes. The assumption is based on the similarity in the average path length and the underlying network infrastructure strongly constraining the shape of a tree.

The simulation was conducted in rounds. During each round a source could only insert one packet to the tree which corresponds to a time tₛ of serializing data on the source output interface. All caches were using the FIFO replacement policy and have enough room to hold a payload for 10 ms, after that time the payload is considered to be evicted. The caching efficiency was measured using (1) for the receiver group size varying from 2 to 1500, by choosing 10 times a random set of receivers from the 1950 leaves and then taking the arithmetic mean. The reduction in the efficiency due to header cost transmission is not taken into account in the following results.

Impact of the Finite Cache Size

The efficiency of the 100 Mbps source is equal to the perfect multicast efficiency because it inserts all packet headers within the cache hold time and no additional payload transmissions occur. The growth of efficiency with the group size suddenly breaks at the point where the packet train time is equal to the cache hold time. At this point caches start to drop the oldest copies of a payload. Thus, whenever the packet train's duration time is larger than the cache hold time the total efficiency is limited by the cache's size and further increase in efficiency with the group size is slow.

Congestion Control

Unlike IP Multicast, link layer caching is independent of the transport protocol. It does not require a common header to all destinations, but only a common payload. Thus, in order to deliver the same data to multiple destinations a source can use existing protocols like TCP, DCCP, or SCTP. In this case each flow is controlled by a separate instance of the transport protocol which regulates independently the packet transmission rate. Since there is no coordination between the flows, the same data chunk might be sent to all of the destinations at different points in time. This in turn affects the efficiency of the technology. Therefore, in order to ensure the efficient use of link caches an additional mechanism synchronizing the flows must be used. This is subject to further research.

The main purpose of this investigation is to examine how the congestion control algorithm of tightly synchronized flows reacts in the presence of the technology. Does it ensure “fair” resource sharing on a bottleneck link? Since the question is very broad, a typical scenario was examined that showed interesting behaviour in an example congestion control. It is expected that the most promising application for the link layer caching is multiple destination live streaming in the Internet. Therefore, this scenario used the case of a single media server streaming to multiple receivers.

ns-2 Implementation and Simulation Setup

The scenario was studied in the network simulator ns-2, which is a discrete event driven simulator. A packet traversing a simulated network does not move between elements in the network, rather the elements pass the packet handler between each other in a series of events. An ns-2 packet is characterized by a set of parameters that are stored in the packet meta-data. One of these packet parameters is the packet size. It is mainly used for calculations of packet delay on a link.

The ns-2 link is modeled by three chained elements: queue, delay, and TTL. According to the packet size and the link capacity the delay element calculates the time to serialize the packet on a link. This time is also used to schedule transmission of the next packet (only when the current packet has been already serialized the next packet can be transmitted). Thus, the modification of the packet size variable is sufficient to simulate the payload removal/recover process.

CMU was implemented as a table where the payload IDs of cacheable packets are stored. When a packet is received by the CMU, its payload ID is compared against those stored in the table, and if a cache hit occurs the packet size is decreased by the payload size. If the payload ID is not found in the table, then the ID is inserted into the table according to the replacement policy. The CMU element is placed between the queue and the delay elements, so that the time to serialize the packet and the time to serve the next packet are calculated according to the new packet size.

Since a payload is not removed from a packet, but only the size of the packet is changed, the implementation of the CS element is straightforward. It simply restores the packet size to its original size. The CS element is placed between the delay and TTL elements. Therefore, the extended link consists of the following five elements that are chained together: queue, CMU, delay, CS, and TTL.

The influence of the technology on congestion controlled transport protocols in the single bottleneck link topology was studied. All links in the topology are caching links. The bottleneck link queue is managed by the RED queueing discipline. ns-2 automatically configured the queue parameters. Two types of traffic compete for the bottleneck link capacity, cacheable and non-cacheable traffic:

Cacheable Traffic

Cacheable traffic was generated by the streaming source and consists of a number of streams. Each stream has a different receiver located behind the bottleneck link but carries the same content. The source generates payloads according to the highest rate from among all stream rates. The RTT between the source and each receiver is the same and is equal to 100 ms. Thus, the streaming rate of the individual flows is fairly the same. TFRC was used to perform congestion control over the media. This decision was mainly influenced by the fact that TFRC was designed for streaming media and it does not produce bursts of packets like TCP does.

Non-Cacheable Traffic

Non-cacheable traffic was represented by 100 TCP flows each originating from a distinct source and having a distinct sink. All of the TCP connections have 100 ms RTT and their throughput is limited only by the bottleneck link.

Two experiments were performed in the aforementioned simulation setup. In both experiments the share of the bottleneck link bandwidth that was consumed by TCP and TFRC flows was measured. Also measured was the average receiver throughput to gain the end host perspective. The results are obtained in simulations that are run for 180 seconds. The first 60 seconds were removed from the measurements to avoid any influence of the transient behaviour of TCP and TFRC.

Effect of Increasing Amount of Receiver

In the first simulation, the number of receivers was exponentially increased in the streaming session. The number of TCP flows is fixed to 100. It is expected that the TFRC flows take incrementally more and more of the bottleneck link bandwidth share with the increasing number of flows; however, this is not the case.

The results showed a surprising TFRC behaviour. The increase in the number of TFRC flows has very little impact on the TFRC shares. 100 TFRC flows obtain only 5% of the bottleneck link while we would expect it to take 50%. However, the average receiver throughput stays fairly constant regardless of the number of receivers.

It is speculated that this behaviour originates from the TFRC congestion control, which competes with TCP on a rate basis. TFRC tries to adjust its sending rate to be “fair” with TCP sending rate. However, when caching is enabled TFRC packets carry only the header part of a packet thus they consume much less of the bottleneck link capacity.

Effect of Decreasing Caching Efficiency

The second simulation analyses the impact of the caching efficiency on the bottleneck link. The caching efficiency metric denotes the ratio of the number of packets without payload to the total number of packets in a packet train. The first packet in a packet train always carries a payload; thus we do not count it. The number of receivers was fixed to 100 and the caching efficiency was gradually decreased. The simulation started with a perfect caching, where only one payload is transmitted per packet train, and was finished with no caching, where all packets carry a payload.

The results of the simulation show that with the decreasing caching efficiency TFRC flows take more and more of the bottleneck link capacity, finally reaching 50% when there is no caching which is “fair” share. Decreasing efficiency affects also the average throughput of the receivers. Without caching the average receiver throughput goes down to 50%.

The link layer caching does not disrupt the current network understanding of fairness. Both TCP and TFRC take advantage of it. In the presence of caching TFRC flows make space for TCP flows on the bottleneck link. However, not all the space is utilized by TCP but also TFRC benefits from it. In the setup the average receiver throughput doubles in the presence of the technology.

Incremental Deployment

The technology is incrementally deployable: it helps to save bandwidth in a network from the very beginning of deployment. This property is ensured by the link cache architecture. A cacheable packet that exits a link is fully reconstructed. The packet payload is attached to the packet header and the whole packet is further processed in a normal way at a router. If the next link on the packet path does not support caching the cacheable packet passes it unmodified (similar to a regular packet). Thus, it is not necessary to change all links in the Internet to start to gain from the technology. Installing a cache on the first hop link from a media server already yields benefits.

The maximum bandwidth savings can be obtained with an Internet wide cache deployment. However, considering incremental deployment the question is what percentage of these savings is obtained with gradual cache deployment. This question can be studied in a simulation using the multicast tree topology from the mwalk project. However, in this experiment it is assumed that there are not additional payload transmissions due to the finite cache sizes. Simulations were conducted for three different group sizes consisting of 10, 100, and 1000 receivers. For each group size, caches were gradually installed in the tree starting from the root and finishing at the leaves. Thus, in the first simulation only the first hop link from the source caches payloads, while remaining links do not. In the second simulation the first two hop links from the source cache packets. The simulation was repeated until the whole tree was covered with caches. In each simulation 10 times a random set of receivers was chosen from the 1950 leaves and then the arithmetic mean was determined. To assess the bandwidth savings, the efficiency metric of equation (1) was used.

Efficiency Gains Per Hop

The percentage of the maximum efficiency (the universal cache deployment) that can be achieved while deploying the caches over a certain number of hops varies depending on the receiver group size. Considering the small group sizes (here represented by 10 receivers) the cache deployment over the first six hops yields already around 70% of what can be achieved. However, in order to achieve this percentage of the maximum efficiency for large group sizes (100 and 1000 receivers) the first nine hops must be covered with caches.

The results depict the efficiency as a fraction of the maximum efficiency, i.e. the efficiency that is obtained by cache deployment in the whole Internet. Additionally, only inter-domain multicast trees are taken into account. However, Internet service providers are mainly interested in their own gains. Thus, the relevant question is what are the direct benefits of deploying caches inside a single ISP? These can be summarized in the following points:
The traffic that is confined to a single ISP will achieve near multicast bandwidth utilization.
The traffic that originates from the ISP and traverses other ISPs will be cached on the way between a streaming source and a gateway inside this ISP. Thus, there will be more spare bandwidth on the ISP's links.

Cacheable and Non-Cacheable Links

One of the core issues of the incremental deployment is the cacheable traffic behaviour on a boundary between a network with the link layer caching and a network without it. Consider a packet train with ten packets that originates from the network with link layer caching and which has destinations in another network without link layer caching. In the first network its size on the link is the size of one payload and ten headers. However, in the second network (which is without caching) its size on the link is the size of ten payloads and ten headers. Thus, it requires much more link capacity in the second network. Therefore, a congestion may occur on the gateway between the networks.

This problem is orthogonal to the link layer caching. The link layer caching increases link capacity. Thus, the problem resembles a situation where a high capacity link is connected with a low capacity link, or where the sum of input link capacities exceeds the capacity of the output link. This problem is addressed by congestion control algorithms, which are usually part of transport protocols. Similarly, the congestion control is responsible for handling the congestion on the boundary between a network with the link layer caching and a network without it. Congestion control ensures “fair” capacity sharing even in the presence of the technology and how it reduces the packet rate when caching efficiency decreases.

3. Proof-of-Concept Implementation

To validate the technology the CMU and the CS units have been implemented in the Click modular router. The basic functionally of the technology elements was implemented as it is described. Additionally, for each packet the CS copies the payload ID and the payload size into packet annotations. Next, the content header is removed and the packet is sent to further processing. The CMU inserts back the content header and the payload size is copied from the packet annotations. The default Click hash tables are used to implement the CMU table.

As a server side implementation of the technology, we introduced a new system call msend(fd set *write fds, fd set *written fds, char *buf, int len) in the Linux OS. It simultaneously writes a data buffer to a set of file descriptors. It is assumed that the file descriptors belong to the DCCP connections. Only open connections that are not congested are written. An application can find which connections were written by inspecting the written fds variable. In result of the msend system call, a tight packet train is generated per neighbour. The payload ID of all packets in the packet train is a subsequent number of this packet train to a given neighbour. The payload size corresponds to the len value that was given in the system call.

Using paraslash tools for client/server audio streaming the implementation was tested. The experiment setup consisted of two desktop class computers (2.4 GHz processor, 512 KB memory). On the first machine was placed a modified paraslash server that was using the msend system call. On the another machine was installed the Click router with the CS unit and paraslash clients. The machines were connected using 100 Mbps Ethernet cable. The link did not become saturated. Around 10 Mbps of cached traffic was achieved, which corresponded to 220 Mbps of non-cached traffic. The limit was on the client side which had to handle around 700 of the paraslash clients and the CS unit. The server side CPU consumption was around 60%.

We claim:

1. A system for managing delivery of a data packet over a network, the system comprising:
a cache management unit operably linked to the network, said cache management unit configured to examine a content header associated with the data packet and determine if a cache hit or a cache miss has occurred; and
a cache store configured to construct a new data packet by associating the content header with a previously stored payload that is the same as the payload if a cache hit has occurred or to store a copy of the payload if a cache miss has occurred, and to prepare the data packet or the new data packet for delivery to an output interface.

2. The system of claim 1, wherein said cache management unit and said cache store reside on one or more routers.

3. The system of claim 2, further comprising a server support configured to associate said content header with said data packet and transmit the data packet via the network.

4. The system of claim 3, wherein said server support and said router are remote from one another on the network.

5. The system of claim 1, wherein the content header comprises a cache index field, a payload identifier, and a payload size.

6. The system of claim 1, wherein the data packet is a cacheable data packet.

7. The system of claim 1, wherein the content header is an IPv6 extension header.

8. The system of claim 1, wherein the content header is located between a link layer header and an IP header.

9. The system of claim 1, wherein the cache management unit receives the data packet from an upstream node of the network, the cache store receives the data packet from the cache management unit, and a downstream node of the network receives the data packet from the cache store.

10. The system of claim 1, wherein the server support marks a data packet that is part of a single source multiple destination transfer as cacheable, adds a content header to the data packet, and sends data packets with the same payloads within a time interval that allows caching.

11. The system of claim 9, wherein the upstream node is a router or a server support.

12. The system of claim 5, wherein the cache management unit is placed at a link entrance and the cache store is placed at a link exit.

13. The system of claim 12, wherein the cache store further comprises a memory slot for storing the payload and the cache management unit further comprises a table for storing the payload identifier associated with the payload, wherein the memory slot is addressable by a payload index and the table is addressable by a payload identifier index, and wherein the payload index and the payload identifier index are the same for a stored payload and its corresponding stored payload identifier.

14. The system of claim 13, wherein
a. if a cache hit has occurred:
i. the cache management unit identifies a previously stored payload identifier in the table that caused the cache hit, determines a second payload identifier index of the previously stored payload identifier, writes the second payload identifier index into the cache index field of the content header, removes the payload from the data packet, and transmits the data packet to the link exit; and
ii. the cache store examines the data packet at the link exit, determines that the data packet consists of only the content header, reads the second payload identifier index from the cache index field of the content header, evaluates a second payload index that is the same as the second payload identifier index, selects a previously stored payload in the memory slot that is addressed by the second payload index, attaches the content header to a copy of the previously stored payload to construct a new data packet, and prepares the new data packet for delivery to an output interface; and
b. if a cache miss has occurred:
i. the cache management system replaces a previously stored payload identifier in the table with the payload identifier of the data packet that caused the cache miss, determines a second payload identifier index of the payload identifier that was inserted into the table, writes the second payload index into the cache index field of the content header, and transmits the data packet to the link exit; and
ii. the cache store examines the data packet at the link exit, determines that the data packet consists of a content header and a payload, reads the second payload identifier index from the cache index field of the content header, evaluates a second payload index that is the same as the second payload identifier index, replaces a previously stored payload in the memory slot with a copy of the payload such that the payload identifier in the table and the corresponding copy of the payload in the memory slot have a payload identifier index and a payload index that are the same, and prepares the data packet for delivery to an output interface.

15. The system of claim 14, wherein a replacement policy governs replacing a previously stored payload identifier in the table.

16. The system of claim 15, wherein the replacement policy is a FIFO replacement policy.

17. The system of claim 13, wherein the table is built using a hash table.

18. The system of claim 13, wherein the cache management unit is configured manually based on a size of the cache store.

19. The system of claim 13, wherein the cache management unit and the cache store are configured automatically based on a capacity of a link that connects the cache management unit and the cache store.

20. The system of claim 13, wherein the payload identifier is stored together with the payload in the memory slot.

21. The system of claim 20, wherein if a cache hit has occurred the cache store reads the payload identifier of the content header, compares the payload identifier of the content header to the stored payload identifier, and drops the payload if the payload identifier of the content header does not match the stored payload identifier.

22. The system of claim 14, wherein preparing the data packet or the new data packet for delivery to an output interface comprises removing the content header.

23. The system of claim 14, wherein a size of the cache store is based on a cache hold time.

24. The system of claim 14, wherein the cache hold time is in the range of 1 ms-500 ms, preferably 5 ms-50 ms.

25. The system of claim 23, wherein the cache hold time is 10 ms.

26. A use of the system of claim 1 to provide a single source multiple destination transfer of data.

27. The use of claim 26, wherein the data comprises live streaming media or a bulk data transfer.

28. The use of claim 26, wherein the data comprises video conferencing, IP radio, IPTV, or software update.

29. A computer implemented process for nonredundant data transfer over a network comprising the steps of:
associating a content header with a data packet, the data packet comprising a payload;
at a node on said network, determining if a cache hit or a cache miss has occurred;
if a cache hit has occurred, constructing a new data packet by associating the content header with a previously stored payload that is the same as the payload;
if a cache miss has occurred, storing a copy of the payload; and
preparing the new data packet or the data packet for delivery to an output interface.

30. The process of claim 29, wherein said node is a router.

31. The process of claim 30, wherein said router is located at a remote location on the network.

32. The process of claim 29, wherein the step of associating a content header with a data packet is performed by a server support, the step of determining if a cache hit or a cache miss has occurred is performed by a cache management unit, and the steps of constructing a new data packet, storing a copy of the payload, and preparing the new data packet or the data packet for delivery to an output interface are performed by a cache store.

33. The process of claim 32, wherein the cache management unit and the cache store are on one or more routers.

34. The process of claim 29, wherein the content header comprises a cache index field, a payload identifier, and a payload size.

35. The process of claim 29, wherein the data packet is a cacheable data packet.

36. The process of claim 29, wherein the content header is an IPv6 extension header.

37. The process of claim 29 further comprising the steps of placing the content header between a link layer header and an IP header.

38. The process of claim 33, wherein the cache management unit receives the data packet from an upstream node of the network, the cache store receives the data packet from the cache management unit, and a downstream node of the network receives the data packet from the cache store.

39. The process of claim 33 further comprising the additional steps of:
marking a data packet that is part of a single source multiple destination transfer as cacheable;
adding a content header to the data packet; and
sending data packets with the same payloads within a time interval that allows caching.

40. The process of claim 39, wherein the additional marking, adding, and sending steps are performed by the server support.

41. The process of claim 32 further comprising the steps of placing the cache management unit at a link entrance and placing the cache store at a link exit.

42. The process of claim 33, wherein the cache store further comprises a memory slot for storing the payload and the cache management unit further comprises a table for storing the payload identifier associated with the payload, wherein the memory slot is addressable by a payload index and the table is addressable by a payload identifier index, and wherein the payload index and the payload identifier index are the same for a stored payload and its corresponding stored payload identifier.

43. The process of claim 42 further comprising the steps of:
if a cache hit has occurred:
identifying a previously stored payload identifier in the table that caused the cache hit;
determining a second payload identifier index of the previously stored payload identifier;
writing the second payload identifier index into the cache index field of the content header;
removing the payload from the data packet;
transmitting the data packet to the link exit;
determining that the data packet consists of only the content header;
reading the second payload identifier index from the cache index field of the content header;
evaluating a second payload index that is the same as the second payload identifier index;
selecting a previously stored payload in the memory slot that is addressed by the second payload index;
attaching the content header to a copy of the previously stored payload to construct a new data packet; and
preparing the new data packet for delivery to an output interface; and
if a cache miss has occurred:
replacing a previously stored payload identifier in the table with the payload identifier of the data packet that caused the cache miss;
determining a second payload identifier index of the payload identifier that was inserted into the table;
writing the second payload index into the cache index field of the content header;
transmitting the data packet to the link exit;
examining the data packet at the link exit;
determining that the data packet consists of a content header and a payload;
reading the second payload identifier index from the cache index field of the content header;
evaluating a second payload index that is the same as the second payload identifier index
replacing a previously stored payload in the memory slot with a copy of the payload such that the payload identifier in the table and the corresponding copy of the payload in the memory slot have a payload identifier index and a payload index that are the same; and
preparing the data packet for delivery to an output interface.

44. The process of claim 43, wherein steps a.i.—a.v. and steps b.i.—b.iv. are performed by the cache management unit and steps a.vi.—a.xii and b.v.—b.x. are performed by the cache store at the link exit.

45. The process of claim 43, wherein the step of replacing a previously stored payload identifier in the table is governed by a replacement policy.

46. The process of claim 45, wherein the replacement policy is a FIFO replacement policy.

47. The process of claim 42 further comprising the step of building the table using a hash table.

48. The process of claim 42 further comprising configuring the cache management unit manually based on a size of the cache store.

49. The process of claim 42 further comprising configuring the cache management unit and the cache store automatically based on a capacity of a link that connects the cache management unit and the cache store.

50. The process of claim 43 further comprising the step of storing the payload identifier together with the payload in the memory slot.

51. The process of claim 50, wherein if a cache hit has occurred, the process further comprises the steps of:
reading the payload identifier of the content header;
comparing the payload identifier of the content header to the stored payload identifier; and
dropping the payload if the payload identifier of the content header does not match the stored payload identifier.

52. The process of claim 43, wherein preparing the data packet or the new data packet for delivery to an output interface comprises the additional step of removing the content header.

53. The process of claim 43 further comprising the step of determining a size of the cache store based on a cache hold time.

54. The process of claim 53, wherein the cache hold time is in the range of 1 ms-500 ms, preferably 5 ms-50 ms.

55. The process of claim 53, wherein the cache hold time is 10 ms.
